(19) United States
(12) Patent Application Publication
(10) Pub. No.: US 2024/0012428 A1
(43) Pub. Date: Jan. 11, 2024

(54) MINE VEHICLE AUTONOMOUS DRIVE CONTROL

(71) Applicant: SANDVIK MINING AND CONSTRUCTION OY, Tampere (FI)

(72) Inventors: Antti LEHTINEN, Tampere (FI); Bjorn IVARSSON, Fagersta (SE); Fredrik SCHMIDT, Nynashamn (SE)

(21) Appl. No.: 18/035,875

(22) PCT Filed: Nov. 12, 2020
(86) PCT No.: PCT/EP2020/081930

§ 371 Date: May 8, 2023

(51) Int. Cl. G05D 1/02

(52) U.S. Cl. CPC G05D 1/0291; G05D 1/0223; G05D 2201/021; E21F 13/00

(57) ABSTRACT

A method includes the steps of detecting a trigger for speed scale setting for a vehicle autonomously operating at an underground worksite and executing a drive order, defining a speed scale for the vehicle on the basis of traffic flow of vehicles at the work site, transmitting a speed scale control message to the vehicle during execution of the drive order, the speed scale control message comprising a speed scale information element indicative of the speed scale, and transmitting, in response to detecting trigger for speed scale cancellation on the basis of updated traffic flow information, a speed scale cancel control message to the vehicle executing the drive order, wherein the speed scale cancel control message indicates cancellation of the speed scale.

### FIELD

The present invention relates to controlling autonomously driving of mine vehicles, and in particular to controlling speed of autonomously operating vehicles executing a drive order.

### BACKGROUND

Mining or construction excavation worksites, such as underground hard rock or soft rock mines, may comprise areas for automated operation of mobile work machines, such as load and/or haul machines and drilling rigs, which may also be referred to as mine vehicles. Such work machine may be an unmanned, e.g. remotely controlled from a control room, or a manned mine vehicle, i.e. operated by an operator in a cabin of the vehicle. Work machines may be configured to perform at least some of tasks autonomously. An automated work machine operating in an automatic mode may operate independently without external control but may be taken under external control at certain operation areas or conditions, such as during states of emergencies.

Underground production areas may comprise a fleet or fleets of vehicles driving at least partly on same routes. Automatic fleet control systems are well-suited for control large production areas such as block-cave and ramp applications. Amount of excavation in passage tunnels is typically aimed to be minimized. Since the vehicles are typically large, there may be very limited options for two vehicles passing each other. Continuous vehicle fleet operation without interruptions is important for worksite production efficiency.

### SUMMARY

The invention is defined by the features of the independent claims. Some specific embodiments are defined in the dependent claims.

According to a first aspect, there is provided an apparatus, comprising: at least one processor; and at least one memory including computer program code, the at least one memory and computer program code being configured to, with the at least one processor, to cause the apparatus for performing: detecting a trigger for speed scale setting for a vehicle autonomously operating at an underground worksite and executing a drive order, defining a speed scale for the vehicle on the basis of traffic flow of vehicles at the work site, transmitting a speed scale control message to the vehicle during execution of the drive order, the speed scale control message comprising a speed scale information element indicative of the speed scale, and transmitting, in response to detecting trigger for speed scale cancellation on the basis of updated traffic flow information, a speed scale cancel control message to the vehicle executing the drive order, wherein the speed scale cancel control message indicates cancellation of the speed scale.

According to a second aspect, there is provided a method, comprising: detecting a trigger for speed scale setting for a vehicle autonomously operating at an underground worksite and executing a drive order, defining a speed scale for the vehicle on the basis of traffic flow of vehicles at the work site, transmitting a speed scale control message to the vehicle during execution of the drive order, the speed scale control message comprising a speed scale information element indicative of the speed scale, and transmitting, in response to detecting trigger for speed scale cancellation on the basis of updated traffic flow information, a speed scale cancel control message to the vehicle executing the drive order, wherein the speed scale cancel control message indicates cancellation of the speed scale.

According to a third aspect, there is provided an apparatus comprising at least one processor, at least one memory including computer program code, the at least one memory and the computer program code being configured to, with the at least one processor, cause the apparatus for performing: receiving a speed scale control message from a fleet supervisory device by the vehicle autonomously operating at a worksite and executing a drive order, the speed scale control message comprising a speed scale information element indicative of speed scale during execution of the drive order, controlling speed of the vehicle in accordance with the speed scale during execution of the drive order, receiving a speed scale cancel control message during execution of the drive order, wherein the speed scale cancel control message indicates cancellation of the speed scale, and cancelling the speed scale in response to the speed scale cancel control message.

According to a fourth aspect, there is provided a method comprising: receiving a speed scale control message from a fleet supervisory device by the vehicle autonomously operating at a worksite and executing a drive order, the speed scale control message comprising a speed scale information element indicative of speed scale during execution of the drive order, controlling speed of the vehicle in accordance with the speed scale during execution of the drive order, receiving a speed scale cancel control message during execution of the drive order, wherein the speed scale cancel control message indicates cancellation of the speed scale, and cancelling the speed scale in response to the speed scale cancel control message

According to a further aspect, there is provided a vehicle or an apparatus, comprising means configured for performing defined by the method or an embodiment thereof. The means may comprise at least one processor; and at least one memory including computer program code, the at least one memory and computer program code configured to, with the at least one processor, cause the performance of the apparatus or the vehicle.

According to a still further aspect, there is provided a computer program, a computer program product or (a non-tangible) computer-readable medium comprising computer program code for, when executed in a data processing apparatus, causing the apparatus to perform the method or an embodiment thereof.

### BRIEF DESCRIPTION OF THE DRAWINGS

FIG. 1 illustrates an example of an underground worksite;

FIG. 2 illustrates an example of an autonomously operating mine vehicle;

FIGS. 3 and 4 illustrate methods according to at least some embodiments;

FIGS. 5a and 5b illustrate top view examples of mine vehicles executing drive orders; and

FIG. 6 illustrate an apparatus capable of supporting at least some embodiments.

### EMBODIMENTS

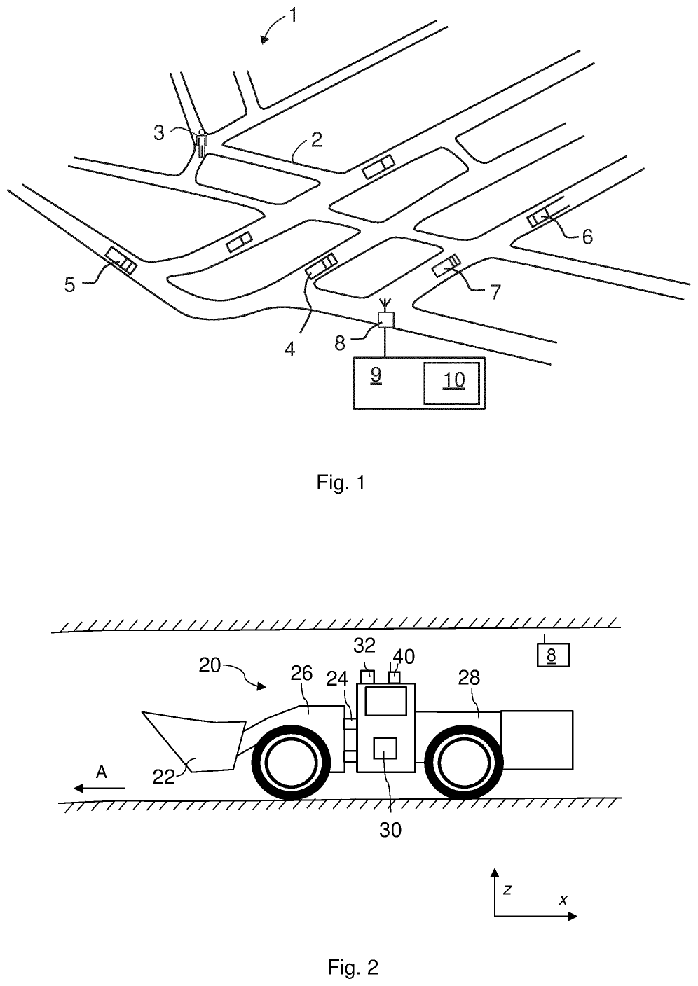

FIG. 1 illustrates a simplified example of an underground worksite 1 comprising a network of underground tunnels 2. A plurality of mobile objects or devices, such as persons or pedestrians 3 and/or mine vehicles 4, 5, 6, 7 may be present in and move between different areas or operation zones of the worksite 1.

The term mine vehicle herein refers generally to mobile work machines suitable to be used in the operation of different kinds of mining and/or construction excavation worksites, such as lorries, dumpers, vans, mobile rock drilling or milling rigs, mobile reinforcement machines, bucket loaders or other kind of mobile work machines which may be used in different kinds of excavation worksites. Hence, the term mine vehicle is not limited in any way to vehicles only for ore mines, but the mine vehicle may be a mobile work machine used at construction excavation sites. A mine vehicle may be an autonomously operating vehicle. The term autonomously operating vehicle herein refers to at least partially automated vehicles. The vehicle may be configured with an autonomous operating mode, during which it may operate/drive independently without requiring continuous user control, but the vehicle may be taken under external control, during states of emergencies, for example.

The worksite 1 comprises a communications system, such as a wireless access system comprising a wireless local area network (WLAN) and/or a cellular communications network, comprising a plurality of wireless access nodes 8. The access nodes 8 may communicate with wireless communications units comprised by the mine vehicles or mobile devices carried by pedestrians and with further communications devices (not shown), such as network device(s) configured to facilitate communications with a control system 9.

The control system 9 may be an on-site (underground or above-ground) and/or remote via intermediate networks. For example, a server of the system 9 may be configured to manage at least some operations at the worksite, such as provide a UI for an operator to remotely monitor and, when needed, control automatic operation operations of the vehicles and/or assign routes and drive orders for a fleet of vehicles and update and/or monitor drive order performance and status. The control system 9 may comprise a fleet supervisory device or apparatus 10, which may refer generally to a data processing device configured to perform vehicle fleet management. For example, the fleet supervisory device 10 may be a server or a part of a server or other type of data processing apparatus.

The control system 9 may be connected to or via a further network(s) and system(s), such a worksite management system, a cloud service, an intermediate communications network, such as the internet, etc. The system may comprise or be connected to further device(s) or control unit(s), such as a handheld user unit, a vehicle unit, a worksite management device/system, a remote control and/or monitoring device/system, data analytics device/system, sensor system/device, etc.

The worksite 1 may further comprise various other types of mine operations devices connectable to the control system 9 e.g. via the access node 8, not illustrated in FIG. 1. Examples of such further mine operations devices include various devices for power supply, environment sensoring, safety, communications, and other automation devices. For example, the worksite may comprise a passage control system comprising passage control units (PCU) separating operation zones, some of which may be set-up for autonomously operating vehicles. The passage control system and associated PCUs may be configured to allow or prevent movement of one or more vehicles and/or pedestrians between zones.

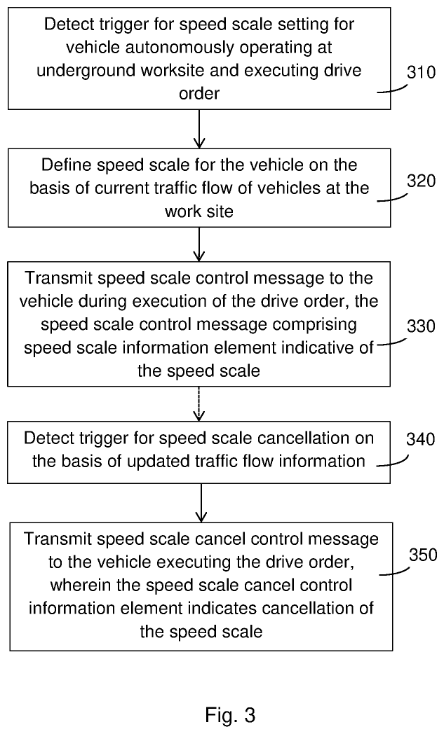

FIG. 2 illustrates a mine vehicle 20, in this example a loader or a load and haul (LHD) vehicle comprising a bucket 22. The vehicle 20 may be an articulated vehicle comprising a front section 26 and a rear section 28 connected by a joint 24. However, it will be appreciated that application of the presently disclosed features for autonomous driving control is not limited to any particular type of vehicle.

The vehicle 20 comprises at least one control unit 30 configured to control at least some functions and/or actuators of the vehicle. The control unit 30 may comprise one or more computing units/processors executing computer program code stored in memory. The control unit may be connected to one or more other control units of a control system of the vehicle, in some embodiments by a controller area network (CAN) bus. The control unit may comprise or be connected to a user interface with a display device as well as operator input interface for receiving operator commands and information to the control unit.

In some embodiments, the control unit 30 is configured to control at least autonomous driving control related operations, and there may be one or more other control units in the vehicle 20 for controlling other operations. It is to be appreciated that the control unit 30 may be configured to perform at least some of the below illustrated features, or a plurality of control units or controllers may be applied to perform these features. There may be further operations, units, modules or functions performed by the control unit(s), e.g. for positioning, steering control, and/or an obstacle avoidance.

The vehicle 20 may be unmanned. Thus, the user interface may be remote from the vehicle and the vehicle may be remotely controlled by an operator, e.g. in a control room at worksite area or long distance away from the mine via communications network(s). A control unit outside the vehicle 20, for example the control system 9 and the device 10 thereof may be configured to perform at least some of the below illustrated features.

The vehicle 20 may comprise one or more scanning units, or scanners 32, configured to perform scanning of the environment of the vehicle. For example, the vehicle may comprise a front scanner configured to scan environment towards normal forward driving direction A (and naturally to sides within reach of the scanner). The vehicle may also comprise a rear scanner configured to scan the environment towards direction opposite to A, i.e. backwards of the vehicle. In an example embodiment, the scanner 32 is a 3D scanner, in which case 3D scanning data, e.g. point cloud data is produced. The scanner 32 may be a laser scanner or another type of sensor device, such as 4D or another type of radar, appropriate for determining obstacles and distances to obstacles for the vehicle.

The scanning results may be applied to detect position and orientation of the vehicle and one or more further elements thereof, such as the scanner 32 or the bucket 22. The control unit 30, or alternatively another control/computation unit in the vehicle, may compare operational scanned tunnel profile data to reference profile data stored in an environment model and position the vehicle on the basis of finding a match in the environment model to position the vehicle and thus operate as scanning position source. The environment model may be obtained based on scanning by (teach-)driving the vehicle or other type of survey, for example. The vehicle 20 may comprise a simultaneous localization and mapping (SLAM) unit configured to both position the vehicle and (augment) map the environment on the basis of (2D or 3D) scanning information while the vehicle is driving. Vehicle status information, such as the position information and speed information, may be reported to the control system 9, and the fleet supervisory device 10 thereof.

The vehicle 20 may be provided with an obstacle detection function or unit, which may be part of a collision avoidance or prevention system and performed by the control unit 30, for example. The obstacle detection function may be configured to perform collision examination based on scanning data received from the scanner 32.

The vehicle 20 may comprise a wireless communication device 40, by which the control unit 20 and/or another unit of control system of the vehicle 20 may establish a data transmission connection to another (second) control system external to the vehicle by utilising a wireless connection provided by a base station or access node 8. The communication device may thus be connected to a communications system of the worksite, such as a wireless access system comprising a wireless local area network (WLAN) and/or a cellular communications network (e.g. a 4G, 5G or another generation cellular network). Non-terrestrial communication by a non-terrestrial transceiver may be configured via a satellite, e.g. by a Third Generation Partnership Project (3GPP) 5G based non-terrestrial network (NTN).

A route or drive plan, may define a route to be driven by the vehicle 20 and may be used as an input for automatic driving of the vehicle. The route plan may be generated offline and off-site, for example in an office, or on-board the vehicle e.g. by a teaching drive. The plan may define a start point and an end point. The route plan may define a set of (intermediate) route points for the automatic drive. Such plan may be sent via a wired or wireless connection to, or otherwise loaded to the vehicle, to a memory of the vehicle for access by the control unit 30 or another unit controlling automatic driving of the vehicle and generating steering parameters or signals to follow the route according to the route plan.

At many worksites, each vehicle of a fleet of vehicles executes its assigned drive order, such as autonomous driving, e.g. for ore hauling, from a loading (start) point to unloading (end) point. Optimization of traffic flow of vehicles driving in challenging and narrow underground conditions is demanding. Appropriate speed setting is an important input substantially affecting the traffic flow and hence excavated material hauling efficiency. Speed also needs to be appropriate to ensure appropriate safety system operations, e.g. obstacle avoidance, and in view of related tunnel floor conditions. Stopping of vehicles should be avoided. However, setting of available speed range for vehicle has been performed before initiating drive order and applied throughout duration of the drive order. There are now provided improvements for controlling speed for autonomously operating vehicles executing a drive order, further illustrated below.

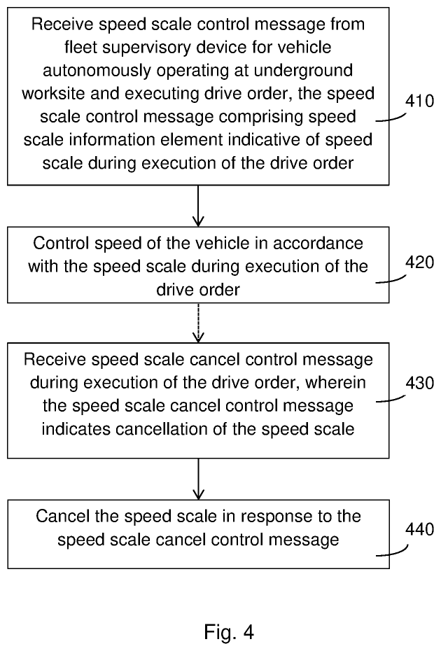

FIG. 3 illustrates a method for a controlling speed for a vehicle by an apparatus, configured for controlling one or more vehicles configured to autonomously operate in a tunnel system of an underground worksite. The method may be implemented by a fleet supervisory apparatus, which may refer generally to an apparatus configured for at least controlling drive orders of the vehicle, such as the fleet supervisory device 10 or a control unit thereof) or server or other kind of appropriately configured data processing device.

Block 310 comprises detecting a trigger for speed scale setting for an underground vehicle (e.g. vehicle 20) autonomously operating at a worksite and executing a drive order. A speed scale is defined in block 320 for the vehicle. The speed scale may be defined on the basis of input information of current traffic flow of vehicles at the work site. The speed scale (information) may be defined to optimize the traffic flow and to avoid unnecessary stopping of the vehicle due to congestion situations.

A speed scale control message is generated and transmitted 330 to the vehicle during execution of the drive order. The speed scale control message comprises a speed scale information element, which may generally refer to an information element indicative of the speed scale.

Vehicle traffic flow may be continuously monitored and updated based on position information received from the vehicles. At a later stage, during execution of the drive order by the vehicle, a trigger for speed scale cancellation for the vehicle may be detected 340 on the basis of updated traffic flow information. In response to the trigger, a speed scale cancel control message is generated and transmitted 340 to the vehicle executing the drive order. The speed scale cancel control message indicates cancellation of the speed scale for the vehicle.

FIG. 4 illustrates a method for controlling speed of a vehicle configured to autonomously operate in a tunnel system of an underground worksite. The method may be implemented by an apparatus configured for at least controlling the vehicle, such as an on-board controller (e.g. the control unit 30) or other kind of appropriately configured data processing device. For example, control system configured to control autonomous driving of the vehicle 20, e.g. a speed control function, unit or module by the control unit 30, may be configured to perform at least some of the steps of FIG. 4. Thus, the method of FIG. 4 may be performed in and by the vehicle, by a control unit in the vehicle.

The method comprises receiving 410 a speed scale control message from a fleet supervisory device, such as the fleet supervisory device 10 performing the method of FIG. 3 and the message of block 330, for (and by) the vehicle autonomously operating at a worksite and executing a drive order. The speed scale control message comprises a speed scale information element indicative of speed scale during execution of the drive order.

Block 420 comprises controlling speed of the vehicle in accordance with the speed scale during execution of the drive order. The vehicle may thus activate the speed scale for the drive order. Current speed profile of the drive order may be adapted in response to the speed scale control message. If the current speed of the exceeds a maximum speed value defined in the speed scale, a deceleration control signal may be issued in or in response to block 420, to reduce the vehicle speed below the maximum speed value. If the speed scale defines a minimum speed threshold value and current speed of the vehicle is below this threshold value, acceleration control signal(s) may be issued in, or in response to block 420 to increase the vehicle speed to exceed the minimum speed threshold value.

At a later stage during execution of the drive order by the vehicle, a speed scale cancel control message is received 430. The speed scale cancel control message indicates cancellation of the speed scale. The speed scale is cancelled 440 in response to the speed scale cancel control message. Thus, speed scale is not affecting speed control of the vehicle any more, and the speed of the vehicle may be controlled in accordance with other speed control related information active or still applying for the vehicle continuing to execute the drive order.

A drive order may generally refer to an order, command, mission, or task instructed by a supervisory system to the vehicle, to at least partially autonomously drive a route at the worksite. The drive order may comprise or refer to a route plan and route point information, which may indicate at least a start point and an end point for the route. The route point information may indicate a sequence of route points to be travelled during execution of the drive order.

On the basis of the route point information and potential further information associated with or comprised by the drive order, a control unit, e.g. the control unit 20, provides control signals to a driveline system of the vehicle during execution of the drive order. The drive order may be initiated by a drive order control message from a control system to the respective vehicle, by the fleet supervisory device 10 or another control unit, e.g. drive orders management unit or module. The vehicle may build a reference route based on received route point information and start execution of the drive order on the basis of the reference route. The drive order may comprise or be associated with further work operations, such as a bucket or frame loading and/or unloading.

During execution of the drive order, the vehicle 20 may transmit periodical status messages to the control system, e.g. the vehicle supervisory device, e.g. by regular 1 Hz interval. The status message may comprise coordinates of the vehicle and potential further information, such as one or more of current speed of the vehicle, current heading of (a body portion of) the vehicle, and reliability of the position information. The speed scale may refer generally to dynamically set and traffic flow dependent speed limitation information defining at least speed that may not be exceeded when performing the drive order.

The present features enable dynamic and instant provision of invocation and cancellation of speed scale for driverless vehicles, based on current worksite traffic flow. This enables to dynamically control speeds of vehicles of the vehicle fleet, to optimize traffic flow. Dynamic speed scale may be adopted and updated without aborting the drive order and the vehicle. Stopping of vehicles may be avoided or reduced, thus facilitating to reduce mechanical wear and energy consumption, and improve hauling efficiency.

There are various options for implementing the methods, and various additional features may be applied, some further example embodiments being illustrated below with references to example entities of FIGS. 1 and 2. Further, it is to be appreciated that although speed scale control for a single vehicle is herewith illustrated, the present features may be applied for controlling speed scale for a group of vehicles, e.g. selectively for defined vehicle of the associated vehicle fleet. The fleet supervisory device 10 may perform the method of FIG. 3 individually for a set of or all autonomously operating vehicles in its supervision area.

In an example embodiment, the trigger is detected in block 310 on the basis of detecting a traffic congestion (potential or upcoming) at a route portion associated with the drive order. The traffic congestion may be defined on the basis of monitored positions, proximity and/or driving directions of vehicles at or approaching a route point. One or more speed scale setting trigger parameters, and associated threshold values, may be predetermined or preconfigured in the system and the fleet supervisory device 10.

There are various implementation options for defining the speed scale in block 320 on the basis of the traffic flow, and these may involve already known methods for optimizing or limiting driving speed based on traffic at an operation area of a vehicle. Traffic flow may generally refer to (driving state) information of a set or fleet of vehicles operating at the worksite, such as position information, speed information drive order information, route information and/or other information (e.g. based on further processing status information received from the fleet of vehicles) indicative of movement and traffic of the fleet of vehicles. The speed scale may be defined on the basis of status information of at least some of the traffic/associated vehicles at a route or route portion associated with the drive order. For example, this may comprise or be based on identifying (affecting/affected) vehicles and their positions at the route (portion), determining distances between vehicles, determining speed of vehicles, and/or determining next driving actions of vehicles. The trigger detection and/or speed scale definition may comprise estimating or predicting future positions the vehicle(s) at future time instants and potential hazardous events at which/on the basis of which a speed scale needs to be set.

In an example embodiment, the trigger is detected 310 and/or the speed scale is defined 320 on the basis of a set of traffic flow parameters (and associated threshold values), which may include one or more of distance or proximity of the vehicle to at least one other vehicle, driving direction of the vehicle (the vehicle for which the method is applied), driving direction of at least one other vehicle, speed of the vehicle, speed of the at least one other vehicle, remaining duration or length of the drive order (may be of a portion of the drive order lapping with remaining drive order of another vehicle), remaining duration or length of a drive order of at least one other vehicle, stopping position of the vehicle, stopping position of at least one other vehicle, departure time of at least one other vehicle, occupancy of a passing bay associated with the drive order, etc.

In an example embodiment, block 310 and/or 320 comprises computing time of arrivals of vehicles passing each other or otherwise travelling at a particular route point. Difference in the time of arrivals may be used as an input parameter and compared to a threshold value. Consideration of other vehicles may be limited to only those vehicles operating during their current (and potentially also subsequent) drive order(s) at least partially in same area of the worksite as the vehicle 20. Below four example scenarios:
1. (Close) vehicle proximity. For example, in parallel passing bays, the supervisory device 10 checks if another vehicle is allocating the passing bay and scales down the speed of a passing vehicle as risk mitigation. If the passing bay is empty, the supervisory device does not scale down the vehicle passing the passing bay.
2. Stop prevention. For example, in long haulage drives/ramps, speed scale is instructed for a vehicle following another vehicle, to avoid stopping of the following vehicle. This may be based on length of consecutive drive orders of the vehicles.
3. Stop prevention. For example, when vehicles are approaching a passing bay from difference directions. The fleet supervisory device 10 may slow down one of the vehicles (e.g. one not driving into the passing bay) for avoiding stoppage and ensuring continuous driving of the passing vehicles at the passing bay area.
4. Stop prevention. For example, when another vehicle is allocating a portion of a next drive order of the vehicle 20 for some reason. The fleet supervisory device may scale down the speed for increasing the likelihood that the vehicle does not need to stop. Departure of the allocating machine may be unknown, or if it is known, the speed may be adapted based on the departure time.

There are various implementation options for including the speed scale information element in the speed scale control message. The speed scale control/deactivation message may be an existing or a new message in communications protocol between mine vehicles 20 and the fleet supervisory device 10, e.g. as part of wireless and IP-based interoperability platform architecture and interface. The speed scale information element may be included as new information in such message. Such architecture may comprise, inter alfa, a mission (or drive order) control interface, controlling drive orders of vehicles. The speed scale control and deactivation message may be included as a new (drive order specific) message type/category, and the speed scale information element may be included as a new information element in such mission control interface and delivered via a communication layer (e.g. user datagram protocol (UDP/)IP based) for such mission interface.

Parameters indicative of at least the speed scale may be encoded in the information element. In an example embodiment, at least one floating value, e.g. by four bytes, is applied to indicate the speed scale. The speed scale control message may comprise an identifier of the associated drive order. The speed scale control message, in the speed scale information element or a further information may comprise further parameters affecting the operations of the vehicle during execution of the drive order and when the speed scale is active (i.e. before receiving the speed scale cancel control message).

The control system of the vehicle, such as the control unit 30 configured to perform the method of FIG. 4, may continuously define speed for the vehicle in block 420 during execution of the drive order. A speed definition or adjustment algorithm may be executed in block 420. The speed scale may serve as an input and boundary (or threshold value for deceleration/acceleration) for the speed definition 420 such that the speed is maintained within the speed scale. For example, the control unit 20 may define speed of the vehicle to a value selected in the range of 5 to 15 km/h.

The speed definition and block 420 may comprise further input parameters (at least some of which may be dynamically changing during execution of the drive order) and control operations based on further criterion and/or threshold values. In an example embodiment, accumulated DR based positioning error or another position accuracy indicator is continuously monitored and applied as an input for speed definition. Some further example inputs for affecting speed control are illustrated below.

As part of block 420, or as a further block, there may be controlling a driveline component of the vehicle 20 in accordance with the defined speed. For example, the control unit 20 may be connected to one or more other control units of a control system of the vehicle, such as an inverter (control) unit driving an electrical motor or other type of motor control unit, in some embodiments via a controller area network (CAN) bus. For example, based on speed control signal from the control unit 20, the inverter unit may control the voltage and frequency of power supplied to an AC motor to control the torque and rotation speed of the electric motor. The control unit may obtain driveline information, e.g. indicative of current speed, provided e.g. to the bus by the inverter unit or a driveline sensor. The speed may be changed gradually, e.g. linearly, reduced to the defined (target) speed, within the speed scale.

A reference speed may be defined for at least a portion of a route associated with the drive order. In an example embodiment, reference speed may be defined in or for route point information, and may be route point specific. The vehicle may be controlled to accelerate or decelerate to the reference speed in response to the speed scale cancel control message 430. The reference speed may be applied as further input in block 420 and/or in/after block 440.

In addition to the speed scale, a speed limit may be controlled for the vehicle 20 for at least one area associated with the drive order. The speed limit may be a further input to block 420 (potentially in addition to the reference speed). The speed limit may comprise a maximum speed value, a speed limit start point, and a speed limit end point.

The fleet supervisory device 10 (or another control source) may control area-specific speed limits. Speed limits may be set to vehicles by transmitting associated control messages, such as limit maximum speed control message. Hence, the vehicle may receive, before or after block 410 a speed limit control message, which may be referred to as e.g. limit maximum speed message, indicative of the speed limit for the at least one area associated with the drive order. Vehicle speed is then controlled in accordance with the speed scale and the speed limit when performing the drive order. Vehicle speed may thus be controlled such that the vehicle speed is within the speed scale and does not exceed the maximum speed limit.

The speed limit instructed for the vehicle 20 may be cancelled by a cancel speed limit control message. The vehicle may be controlled to, after cancellation of the speed limit, continue controlling speed of the vehicle in accordance with the speed scale before receiving the speed scale cancel control message.

The vehicle 20 may thus be controlled to apply speed reduction and speed scaling simultaneously. Also other limitation functions may affect space or range of speed values available for the vehicle to select the tramming/driving speed in block 420. There are various options for prioritizing or applying potentially overlapping limitations or limitation functions regarding or affecting the speed of the vehicle during execution of the drive order. On-board navigation system of the vehicle may be configured to define the applied tramming/driving speed target as the floor or window available on the basis of the limiting functions and the reference speed.

In an example embodiment, the speed limit may override the speed scale. The speed control in block 420 may comprise (continuing) to prevent speed of the vehicle 20 to exceed the maximum speed value also after receiving 410 the speed scale control message. If the speed limit is controlled for a route area/portion of the drive order, e.g. due to poor road conditions, it is not exceeded, although speed scale would enable higher speed for the vehicle. However, when, on the basis of position information, the vehicle is detected to exit (or be outside of) the route area associated with the speed limit, e.g. at a route after the speed limit end point the vehicle is controlled to (return) to speed according to the speed scale control message (unless it has been cancelled during application of the speed limit).

The speed scale may override the reference speed defined for at least a portion of a route associated with the drive order. In such case, the vehicle 20 may be controlled to deviate from the reference speed, if the reference speed is outside the speed scale. Speed scale may reduce the reference speed, i.e. if maximum speed according to the speed scale is lower than the reference speed, the vehicle is controlled not to exceed the speed scale. The vehicle may thus be controlled to decelerate from the reference speed to a speed value within the speed scale. However, if speed scaled on the basis of the speed scale would be higher than the reference speed (i.e. maximum speed according to the speed scale exceeds the reference speed), the vehicle may be configured to prevent exceeding the reference speed. The vehicle may thus control speed of the vehicle to the reference speed. In a further example, the vehicle may, after cancellation of the speed limit, revert to the reference speed, if available and within the speed scale.

In some cases, the initial drive order control message, for initiating the drive order, may comprise a speed scale information element. Such drive order specific, non-dynamic, speed scale may be overridden by the (subsequent drive order specific) speed scale control message (and the speed scale defined therein) of block 330, 410 during the execution of the drive order. Further, in response to block 430, the vehicle 20 may return to apply the initial drive order specific speed scale.

The speed scale may be deactivated in response to the vehicle 20 completing the drive order (if the speed scale cancel control message is not received during the execution of the drive order). The speed scale may be deactivated also in response to an express input from an operator, e.g. to stop the vehicle or abort the drive order.

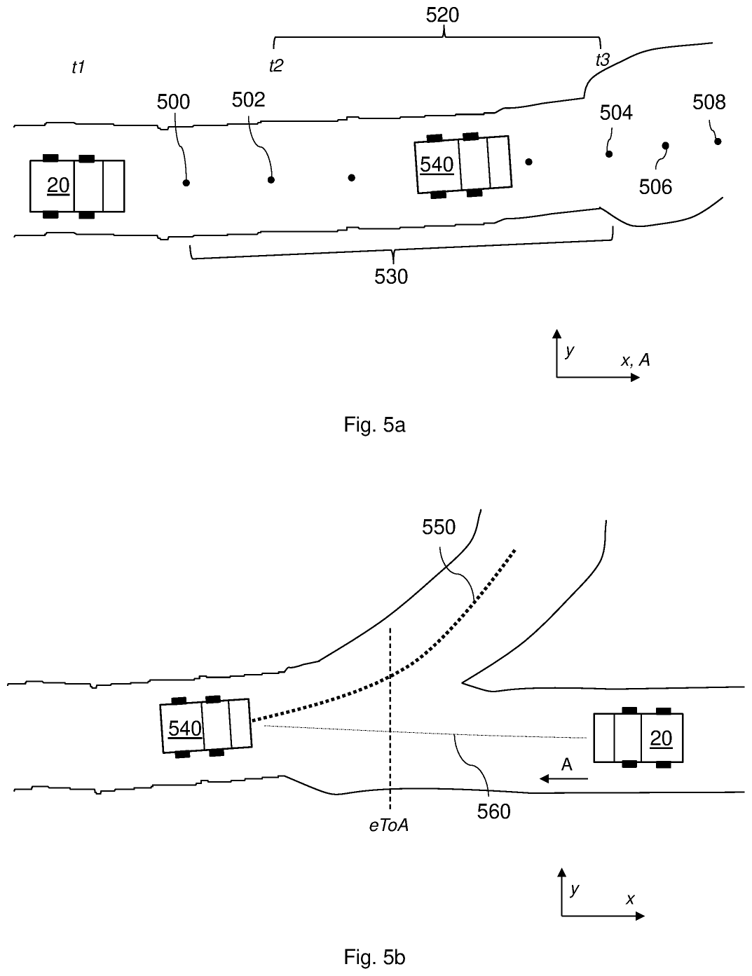

FIG. 5a illustrates a top view example, in which the vehicle 20 is executing a drive order and driving between tunnel walls along a route associated with the drive order and indicated by route points 500, 502, 504, 506, and 508. The vehicle 20 is illustrated at time instant t1 driving towards route point 500. In this simple example, the route may have a reference speed, e.g. 20 km/h, which is applicable for all route points of the route. A speed limit, e.g. 12 km/h, may be defined by route points 500 and 504 as speed limit start point and speed limit end point, respectively. This may be due to poor road conditions in the area between points 500 and 504, for example.

When executing the drive order, e.g. when the vehicle 20 is at route point 502 (not shown) at time instant t2, dynamic speed scale may be instructed to the vehicle by a speed scale control message from the supervisory device 10. The speed scale may instruct the vehicle to drive at further reduced speed, for example in the range between 5 to 7 km/h. This may be due to current traffic flow situation at the work site.

In a simple example, the speed scale may be triggered due to distance of the vehicle 20 to another vehicle 540 ahead falling below a threshold value. The other vehicle 540 may have decreased its speed e.g. due to a speed scale command due to further traffic ahead, or to stop at point 508 to allow other traffic to pass. The speed scale overrides the speed limit of area 530, so the vehicle 20 instantly upon the speed scale control message at t2 reduces speed.

When a trigger for speed scale cancellation is detected, e.g. when the vehicle 540 has accelerated and the distance between vehicles 20 and 540 exceeds an associated threshold value, the supervisory device 10 transmits a speed scale cancel control message to the vehicle 20. At time instant t3, when the vehicle 20 is at route point 504, the vehicle 20 cancels, in response to the cancel control message, the speed scale applied during period 520. The vehicle may then return to higher speed according to the speed limit (and then further to the reference speed after the end of the speed limit area 530).

FIG. 5b illustrates another example, in which the vehicle 20 is driving towards a tunnel crossing approached also by another vehicle 540. Drive order and associated route 550 of the vehicle 540 will lead the vehicle to turn to the branch in left, whereas the route 560 of the vehicle 20 will continue forward.

The fleet supervisory device 10 may detect, as part of check procedure performed e.g. for vehicle 20, that these vehicles have partially overlapping route portions and they are driving towards each other. On the basis of current position and speed of the vehicles, the supervisory device may estimate if there is a risk for collision. This may be performed by computing estimated time of arrival eToA e.g. at the illustrated crossing point for both vehicles. If the eToAs are too close, i.e. the difference between them is below an associated (trigger) threshold value, trigger for speed scale for the vehicle 20 may be detected. Thus, the speed of the vehicle 20 may be limited by the speed scale to ensure adequate distance between the vehicles and/or time difference at a common route point, to avoid stopping the vehicle. For example, the speed scale may be defined such that the difference between the eToA of the vehicle 540 and an updated eToA of the vehicle 20 by the scaled down speed exceeds the (trigger) threshold value (or another threshold value for ensuring adequate distance between vehicles passing the common route position).

In a still further example, when the vehicle 20 is slowly approaching the crossing and waiting for the vehicle 540 to drive through the crossing, a still further third vehicle (not shown) may be driving after the vehicle 20 in direction A. The fleet control device may detect, based on the slowing/slower speed of the vehicle 20 and position (and potentially speed) of the third vehicle, trigger for speed scale setting for the third vehicle. Such situation may be detected or classified as vehicle traffic congestion situation. The speed scale may be defined for the third vehicle based on position of the third vehicle and position and speed of the vehicle 20, for example. If available, the eToA or estimated time of departure (e.g. from the indicated eToA point at the crossing) of the vehicle 20 may be applied for defining the speed scale for the third device. The speed scale may be defined such that the third device does not stop before the vehicle 20 proceeds further at the crossing (the vehicle 20 may instantly automatically accelerate after passing the crossing or after the vehicle 540 has passed the crossing). In an embodiment, the speed scale for the third vehicle is defined on the basis of the speed scale defined for the vehicle 20, behind which the third vehicle is driving (and which it is approaching). However, it will be appreciated that these are just some simple examples of potential situations and implementation options, on when and how speed scale may be applied.

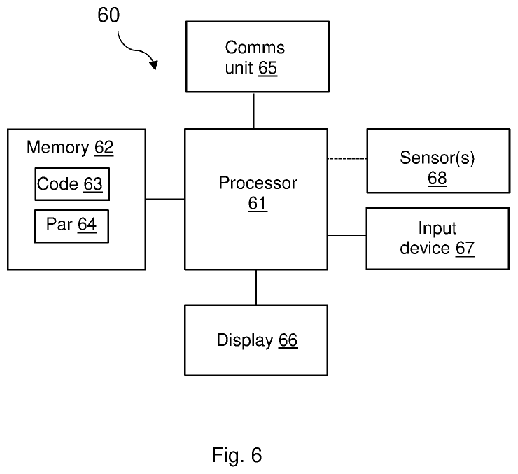

FIG. 6 illustrates an example apparatus capable of supporting at least some embodiments. Illustrated is a device 60, which may be configured to carry out at least some of the above illustrated embodiments relating to the dynamic speed scale control. The device may comprise or implement a control unit 30 of a vehicle 20 configured to at least perform the method of FIG. 3. In another example embodiment, a supervisory device performing the method of FIG. 4 may comprise the device 60 or at least some elements thereof.

Comprised in the device 60 is a processor 61, which may comprise, for example, a single- or multi-core processor. The processor 61 may comprise more than one processor. The processor may comprise at least one application-specific integrated circuit, ASIC. The processor may comprise at least one field-programmable gate array, FPGA. The processor may be configured, at least in part by computer instructions, to perform actions.

The device 60 may comprise memory 62. The memory may comprise random-access memory and/or permanent memory. The memory may be at least in part accessible to the processor 61. The memory may be at least in part comprised in the processor 61. The memory may be at least in part external to the device 60 but accessible to the device. The memory 62 may be means for storing information, such as parameters 64 affecting operations of the device. The parameter information in particular may comprise parameter information affecting e.g. the dynamic speed scale control or application, such as threshold values.

The memory 62 may comprise computer program code 63 including computer instructions that the processor 61 is configured to execute. When computer instructions configured to cause the processor to perform certain actions are stored in the memory, and the device in overall is configured to run under the direction of the processor using computer instructions from the memory, the processor and/or its at least one processing core may be considered to be configured to perform said certain actions. The processor may, together with the memory and computer program code, form means for performing at least some of the above-illustrated method blocks in the device.

The device 60 may comprise a communications unit 65 comprising a transmitter and/or a receiver. The transmitter and the receiver may be configured to transmit and receive, respectively, information in accordance with at least one cellular or non-cellular standard. The transmitter and/or receiver may be configured to operate in accordance with global system for mobile communication, GSM, wideband code division multiple access, WCDMA, long term evolution, LTE, 3 GPP new radio access technology (N-RAT), wireless local area network, WLAN, and/or Ethernet, for example.

The device 60 may comprise or be connected to a UI. The UI may comprise at least one of a display 66, a speaker, an input device 67 such as a keyboard, a joystick, a touchscreen, and/or a microphone. The UI may be configured to display views on the basis of the worksite model(s) and the mobile object position indicators. A user may operate the device and control at least some aspects of the presently disclosed features, such as setting parameters affecting the speed and speed scale control. In some embodiments, the user may control the vehicle 30 via the UI, for example to change operation mode, change display views, modify parameters 64 in response to user authentication and adequate rights associated with the user, etc.

The device 60 may further comprise and/or be connected to further units, devices and systems, such as one or more sensor devices 68, such as the scanner(s) 32 or other sensor devices sensing environment of the device 60 or properties of the mine vehicle.

The processor 61, the memory 62, the communications unit 65 and the UI may be interconnected by electrical leads internal to the device 60 in a multitude of different ways. For example, each of the aforementioned devices may be separately connected to a master bus internal to the device, to allow for the devices to exchange information. However, as the skilled person will appreciate, this is only one example and depending on the embodiment various ways of interconnecting at least two of the aforementioned devices may be selected without departing from the scope of the present invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

1. A fleet supervisory apparatus, comprising:
at least one processor; and
at least one memory including computer program code, the at least one memory and computer program code being configured to, with the at least one processor, to cause the apparatus to perform:
detecting a trigger for speed scale setting for a vehicle autonomously;
operating at an underground worksite and executing a drive order;
defining a speed scale for the vehicle on the basis of traffic flow of vehicles at the work site;
transmitting a speed scale control message to the vehicle during execution of the drive order, the speed scale control message comprising a speed scale information element indicative of the speed scale; and
transmitting, in response to detecting trigger for speed scale cancellation on the basis of updated traffic flow information, a speed scale cancel control message to the vehicle executing the drive order, wherein the speed scale cancel control message indicates cancellation of the speed scale.

2. The apparatus of claim 1, wherein the apparatus is configured to control, in addition to the speed scale, a speed limit for the vehicle for at least one area associated with the drive order, the speed limit including a maximum speed value, a speed limit start point, and a speed limit end point, for preventing speed of the vehicle to exceed the maximum speed value also after receiving the speed scale control message.

3. The apparatus of claim 1, wherein the apparatus is configured to detect the trigger and/or define the speed scale on the basis of a set of traffic flow parameters including one or more of: distance or proximity of the vehicle to at least one other vehicle, driving direction of the vehicle, driving direction of at least one other vehicle, speed of the vehicle, speed of the at least one other vehicle, remaining duration or length of the drive order, remaining duration or length of a drive order of at least one other vehicle, stopping position of the vehicle, stopping position of at least one other vehicle, departure time of at least one other vehicle, occupancy of a passing bay associated with the drive order.

4. An apparatus for an underground vehicle, the apparatus comprising:
at least one processor; and
at least one memory including computer program code, the at least one memory and computer program code being configured to, with the at least one processor, to cause the apparatus to perform:
receiving a speed scale control message from a fleet supervisory device for the vehicle autonomously operating at a worksite and executing a drive order, the speed scale control message comprising a speed scale information element indicative of speed scale during execution of the drive order;
controlling speed of the vehicle in accordance with the speed scale during execution of the drive order;
receiving a speed scale cancel control message during execution of the drive order, wherein the speed scale cancel control message indicates cancellation of the speed scale; and
cancelling the speed scale in response to the speed scale cancel control message.

5. The apparatus of claim 4, wherein the apparatus is configured to adapt a speed profile of the drive order of the vehicle in response to the speed scale control message.

6. The apparatus of claim 4, wherein the apparatus is configured to define a reference speed for at least a portion of a route associated with the drive order and the apparatus is configured to control the vehicle to accelerate or decelerate to the reference speed in response to the speed scale cancel control message.

7. The apparatus of claim 4, wherein a speed limit is defined for at least one area associated with the drive order, wherein the speed limit includes a maximum speed value, a speed limit start point, and a speed limit end point, and wherein the apparatus is configured to prevent speed of the vehicle from exceeding the maximum speed value in the at least one area associated with the drive order.

8. The apparatus of claim 7, wherein the apparatus is further configured to perform:
receiving a limit maximum speed control message, indicative of the speed limit for the at least one area associated with the drive order; and
on the basis of the limit maximum speed control message and the speed scale control message, controlling the speed of the vehicle in accordance with the speed scale and the speed limit when performing the drive order, such that the vehicle speed is within the speed scale and does not exceed the maximum speed limit.

9. The apparatus of claim 7, wherein the apparatus is configured to continue controlling the speed of the vehicle to a value within the speed scale in response to detecting the vehicle to exit the at least one area associated with the drive order.

10. The apparatus of claim 4, wherein the apparatus is further configured to control at least one of: transmit to the fleet supervisory device a speed scale activated message indicative of activating the speed scale in response to the speed scale control message, and transmit to the fleet supervisory device a speed scale cancelled message indicative of removing or cancelling the speed scale in response to the speed scale cancel control message.

11. The apparatus of claim 4, wherein the apparatus is configured to deactivate the speed scale for controlling the speed of the vehicle in response to completing the drive order.

12. An underground vehicle, comprising the apparatus of claim 4.

13. A method for a fleet supervisory apparatus, comprising:
detecting a trigger for speed scale setting for a vehicle autonomously operating at an underground worksite and executing a drive order;
defining a speed scale for the vehicle on the basis of traffic flow of vehicles at the work site;
transmitting a speed scale control message to the vehicle during execution of the drive order, the speed scale control message comprising a speed scale information element indicative of the speed scale; and
transmitting in response to detecting trigger for speed scale cancellation on the basis of updated traffic flow information, a speed scale cancel control message to the vehicle executing the drive order, wherein the speed scale cancel control message indicates cancellation of the speed scale.

14. The method of claim 13, wherein, in addition to the speed scale, a speed limit is controlled for the vehicle for at least one area associated with the drive order, the speed limit including a maximum speed value, a speed limit start point, and a speed limit end point, for preventing speed of the vehicle to exceed the maximum speed value also after receiving the speed scale control message.

15. The method of claim 13, wherein the trigger is detected and/or the speed scale defined on the basis of a set of traffic flow parameters including one or more of: a distance or proximity of the vehicle to at least one other vehicle, driving direction of the vehicle, driving direction of at least one other vehicle, speed of the vehicle, speed of the at least one other vehicle, remaining duration or length of the drive order, remaining duration or length of a drive order of at least one other vehicle, stopping position of the vehicle, stopping position of at least one other vehicle, departure time of at least one other vehicle, occupancy of a passing bay associated with the drive order.

16. A method for an underground vehicle, comprising:
receiving a speed scale control message from a fleet supervisory device by the vehicle autonomously operating at a worksite and executing a drive order, the speed scale control message comprising a speed scale information element indicative of speed scale during execution of the drive order;
controlling speed of the vehicle in accordance with the speed scale during execution of the drive order;
receiving a speed scale cancel control message during execution of the drive order, wherein the speed scale cancel control message indicates cancellation of the speed scale; and
cancelling the speed scale in response to the speed scale cancel control message.

17. The method of claim 16, wherein a speed profile of the drive order of the vehicle is adjusted in response to the speed scale control message.

18. The method of claim 16, wherein a reference speed is defined for at least a portion of a route associated with the drive order and the apparatus is configured to control the vehicle to accelerate or decelerate to the reference speed in response to the speed scale cancel control message.

19. The method of claim 16, wherein a speed limit is defined for at least one area associated with the drive order, wherein the speed limit comprises a maximum speed value, a speed limit start point, and a speed limit end point, and the apparatus is configured to prevent speed of the vehicle to exceed the maximum speed value in the at least one area associated with the drive order.

20. The method of claim 19, further comprising:
receiving a limit maximum speed control message, indicative of the speed limit for the at least one area associated with the drive order; and
on the basis of the limit maximum speed control message and the speed scale control message, controlling the speed of the vehicle in accordance with the speed scale and the speed limit when performing the drive order, such that the vehicle speed is within the speed scale and does not exceed the maximum speed limit.

21. The method of claim 19, further comprising continuing controlling the speed of the vehicle to a value within the speed scale in response to detecting the vehicle to exit the at least one area associated with the drive order.

22. The method of claim 16, further comprising controlling at least one of: transmit to the fleet supervisory device a speed scale activated message indicative of activating the speed scale in response to the speed scale control message, and transmit to the fleet supervisory device a speed scale cancelled message indicative of removing or cancelling the speed scale in response to the speed scale cancel control message.

23. The method of claim 16, further comprising deactivating the speed scale for controlling the speed of the vehicle in response to completing the drive order.

24. A computer program, comprising computer program code for, when executed in a data processing apparatus, causes the apparatus to perform the method of claim 13.

25. A non-tangible computer-readable medium, comprising computer program code for, when executed in a data processing apparatus, causes the apparatus to perform the method of claim 13.

26. A computer program, comprising computer program code for, when executed in a data processing apparatus, causes the apparatus to perform the method of claim 16.

27. A non-tangible computer-readable medium, comprising computer program code for, when executed in a data processing apparatus, causes the apparatus to perform the method of claim 16.
